(19) United States
(12) Patent Application Publication
(10) Pub. No.: US 2011/0102397 A1
(43) Pub. Date: May 5, 2011

(54) ELECTROPHORETIC DISPLAY DEVICE, DRIVING METHOD THEREOF, AND ELECTRONIC APPARATUS

(75) Inventor: Katsunori YAMAZAKI, Matsumoto (JP)

(73) Assignee: SEIKO EPSON CORPORATION, Tokyo (JP)

(21) Appl. No.: 12/913,832

(22) Filed: Oct. 28, 2010

(30) Foreign Application Priority Data
Oct. 30, 2009 (JP) 2009-250326

(51) Int. Cl. G09G 5/00; G09G 3/34

(52) U.S. Cl. 345/208; 345/107

(57) ABSTRACT

Disclosed is an electrophoretic display device including an electrophoretic element, a scanning line and a data line, a pixel formed corresponding to an intersection parts of the scanning line and the data line, and a power line connected to the pixel. The pixel is provided with a pixel electrode, a select transistor having a gate connected to the scanning line, a first driving transistor having a gate connected to the data line, and a second driving transistor having a gate connected to a drain of the first driving transistor, and a source connected to the power line. A ramp waveform is input to the gate of the second driving transistor through the first driving transistor, and a current flows between the power line and the pixel electrode through the second driving transistor.

### BACKGROUND

1. Technical Field

The present invention relates to an electrophoretic display device, a driving method thereof, and an electronic apparatus.

2. Related Art

A current driving-type electrophoretic display device is known, in which a first transistor connected to a scanning line and a data line, and a second transistor having a gate connected to a drain of the first transistor are provided for each pixel (for example, refer to JP-A-2008-176330).

In the electrophoretic display device disclosed in JP-A-2008-176330, a gate voltage of the second transistor is determined according to a voltage between a gate and a source of the first transistor when the first transistor is turned on. A current corresponding to the gate voltage is supplied to an electrophoretic element through the second transistor. Thus, in the case of performing a multi-grayscale display, since it is necessary to input potentials different from each other to signal lines, the configuration of a signal line driving circuit for driving the signal lines may be complicated.

### SUMMARY

An advantage of some aspects of the invention is to provide an electrophoretic display device which enables a multi-grayscale display without complicating a driving circuit, and a driving method thereof.

According to a first aspect of the invention, there is provided an electrophoretic display device including an electrophoretic element interposed between a pair of substrates, a plurality of scanning lines and a plurality of data lines extending in directions intersecting each other, pixels formed corresponding to intersection parts of the scanning lines and the data lines, and a power line connected to the pixels, wherein each pixel is provided with a pixel electrode, a select transistor having a gate connected to the scanning line, a first driving transistor having a gate directly connected to the data line or connected to the data line through other elements, and a second driving transistor having a gate directly connected to a drain of the first driving transistor or connected to the drain of the first driving transistor through other elements, and a source connected to the power line, wherein a ramp waveform is input to the gate of the second driving transistor through the first driving transistor, and wherein a current flows between the power line and the pixel electrode through the second driving transistor.

With such a configuration, it is possible to control the potential level of the ramp waveform input to the gate of the second driving transistor by using the first driving transistor. Consequently, since it is possible to control the current flowing between the power line and the pixel electrode through the second driving transistor, display grayscale of the electrophoretic element driven by the current can be controlled. Furthermore, it is not necessary to provide a voltage selection circuit to each data line in the same manner as an existing electrophoretic display device. Thus, in accordance with the present invention, a multi-grayscale display can be performed without complicating the configuration of a driving circuit.

It is possible to employ a configuration in which a scanning line different from the scanning line connected to the pixel, or a ramp waveform signal line for supplying the ramp waveform, is connected to a source of the first driving transistor, and a source of the select transistor is connected to the drain of the first driving transistor.

In accordance with the electrophoretic display device having such a configuration, an electrical connection between the first driving transistor and the second driving transistor can be switched using the select transistor, and the potential of the ramp waveform input to the gate of the second driving transistor can be controlled using the first driving transistor.

It is possible to employ a configuration in which a scanning line different from the scanning line connected to the pixel or a ramp waveform signal line for supplying the ramp waveform is connected to a source of the first driving transistor, and a drain of the select transistor is connected to the gate of the first driving transistor.

In accordance with the electrophoretic display device having such a configuration, the on-period of the first driving transistor is controlled using a signal input to the gate of the first driving transistor through the select transistor, and thus the potential of the ramp waveform input to the gate of the second driving transistor is controlled, so that a current flowing through the pixel electrode can be controlled.

Preferably, the scanning line connected to the first driving transistor is a scanning line of an adjacent row.

With such a configuration, since a ramp waveform and a selection signal (a potential for allowing the select transistor to be turned on) input to the scanning line of the adjacent row can be formed of one waveform, the configuration of a scanning line driving circuit can be prevented from being complicated.

Preferably, a pulse with a pulse width equal to or less than a selection period of the pixel is input to the gate of the first driving transistor. With such a configuration, it is possible to easily realize a configuration in which an arbitrary potential is selected from potentials of a ramp waveform changing with the passage of time and is input to the gate of the second driving transistor.

Preferably, the ramp waveform is supplied to the pixel only in a period in which a potential for allowing the select transistor to be turned on is input to the scanning line.

Thus, since the ramp waveform can be selectively supplied only to the pixel that performs a display operation, it is possible to suppress power consumption due to charge and discharge of parasitic capacitance between a wiring for supplying a ramp waveform and other wirings.

Preferably, a display unit is provided with a main signal line for supplying the ramp waveform, and ramp waveform signal lines formed corresponding to the scanning lines of each row to supply the ramp waveform to the pixel belonging to the scanning line, the respective ramp waveform signal lines are connected to the main signal line through a signal control transistor, and the scanning line is connected to a gate of the signal control transistor.

With such a configuration, since the ramp waveform is supplied from the main signal line to the ramp waveform signal line only in a period in which the scanning line is selected, it is possible to reduce the occurrence positions of charge and discharge of parasitic capacitance due to the ramp waveform with potentials frequently changed, and power consumption can be reduced.

According to a second aspect of the invention, there is provided a driving method of an electrophoretic display device including an electrophoretic element interposed between a pair of substrates, a plurality of scanning lines and a plurality of data lines extending in directions intersecting each other, pixels formed corresponding to intersection parts of the scanning lines and the data lines, and a power line connected to the pixels, whereby each pixel is provided with a pixel electrode, a select transistor having a gate connected to the scanning line, a first driving transistor having a gate directly connected to the data line or connected to the data line through other elements, and a second driving transistor having a gate directly connected to a drain of the first driving transistor or connected to the drain of the first driving transistor through other elements, and a source connected to the power line, the method including: allowing the pixel to be in a selection state by turning on the select transistor at a state where a ramp waveform is supplied to a source of the first driving transistor when an image is displayed on a display unit; inputting a part or the whole of the ramp waveform to the gate of the second driving transistor by allowing the first driving transistor to be selectively turned on in a predetermined period in a period in which the select transistor is turned on; and allowing a current to flow between the power line and the pixel electrode through the second driving transistor.

With such a driving method, since it is possible to control the potential level of the ramp waveform input to the gate of the second driving transistor by using the first driving transistor and thus control the current flowing between the power line and the pixel electrode through the second driving transistor, display grayscale of the electrophoretic element driven by the current can be freely controlled. Furthermore, it is not necessary to provide a voltage selection circuit to each data line as with an existing electrophoretic display device. Consequently, in accordance with the present invention, a multi-grayscale display can be performed without using a complicated driving circuit.

Preferably, the ramp waveform is supplied to the first driving transistor through a scanning line different from the scanning line connected to the pixel.

Thus, since it is not necessary to separately provide the ramp waveform signal line for supplying the ramp waveform, the driving method can be applied to an electrophoretic display device without a significant change in the existing configuration of a display unit.

Preferably, the ramp waveform is supplied to the first driving transistor from the scanning line of an adjacent row of the pixel.

Thus, the driving method can prevent a scanning line driving circuit from being complicated.

An electronic apparatus of the present invention is provided with the above-described electrophoretic display device.

It is possible to realize a low-cost electronic apparatus by employing a display unit capable of performing a multi-grayscale display using a driving circuit with a simple configuration.

### BRIEF DESCRIPTION OF THE DRAWINGS

The invention will be described with reference to the accompanying drawings, wherein like numbers reference like elements.

FIG. 1 is a configuration diagram schematically showing an electrophoretic display device in accordance with a first embodiment.

FIG. 2 is a diagram showing a pixel circuit in accordance with a first embodiment.

FIGS. 3A and 3B are sectional views showing main elements of an electrophoretic display device in accordance with a first embodiment.

FIGS. 4A and 4B are diagrams explaining the operation of an electrophoretic element.

FIG. 5 is a timing chart showing a driving method in accordance with a first embodiment.

FIG. 6 is a diagram showing a pixel circuit in accordance with a modified example.

FIG. 7 is a diagram showing a pixel circuit in accordance with a second embodiment.

FIG. 8 is a timing chart showing a driving method in accordance with a second embodiment.

FIG. 9 is a diagram showing a pixel circuit in accordance with a third embodiment.

FIG. 10 is a diagram showing one example of an electronic apparatus.

FIG. 11 is a diagram showing one example of an electronic apparatus.

FIG. 12 is a diagram showing one example of an electronic apparatus.

### DESCRIPTION OF EXEMPLARY EMBODIMENTS

Hereinafter, embodiments of the present invention will be described with reference to the accompanying drawings.

The scope of the present invention is not limited to the following embodiments, and various modified examples can be made within the technical features of the present invention. Furthermore, in the following drawings, for the purpose of a clear explanation of elements, the sizes and the number of the elements may be reduced or magnified from the real size thereof.

### First Embodiment

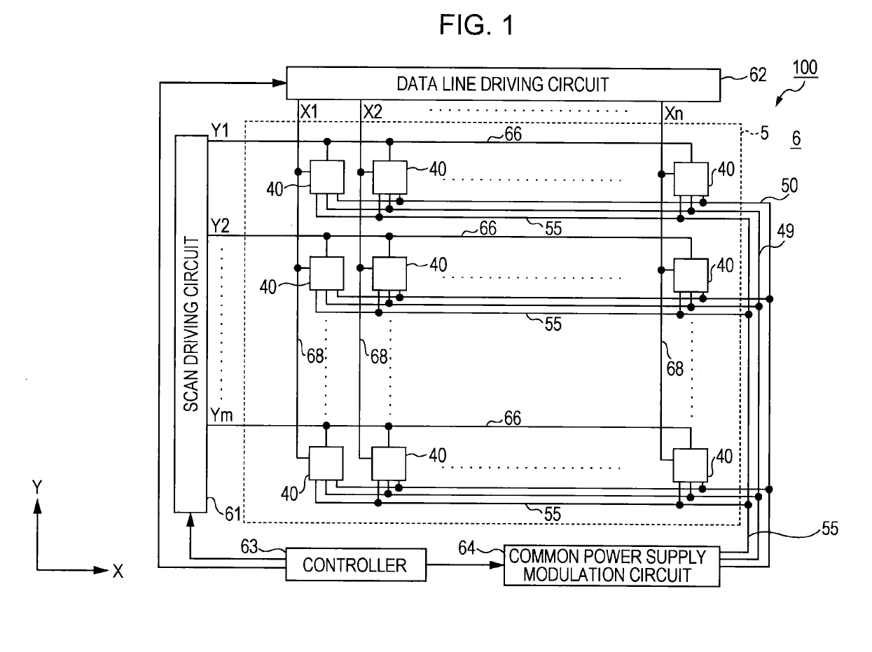

FIG. 1 is a configuration diagram schematically showing an electrophoretic display device 100 in accordance with the first embodiment of the present invention.

The electrophoretic display device 100 includes a display unit 5 in which a plurality of pixels 40 are arranged in a matrix form. A scanning line driving circuit 61, a data line driving circuit 62, a controller 63, and a common power supply modulation circuit 64 are disposed around the display unit 5. The scanning line driving circuit 61, the data line driving circuit 62, and the common power supply modulation circuit 64 are connected to the controller 63. The controller 63 comprehensively controls the scanning line driving circuit 61, the data line driving circuit 62, and the common power supply modulation circuit 64 based on image data or a synchronization signal supplied from an upper device.

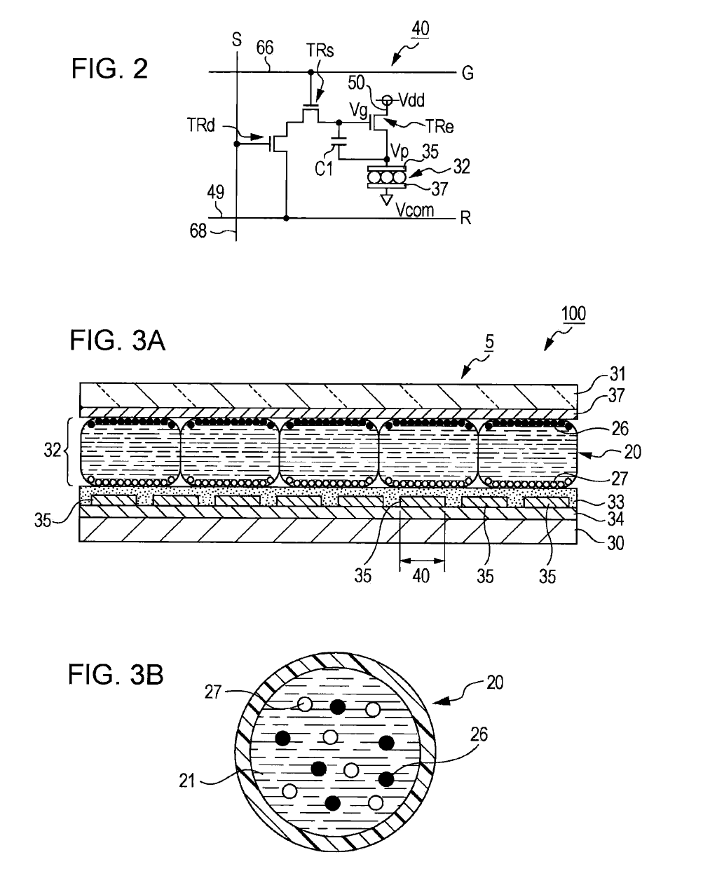

The display unit 5 is provided with a plurality of scanning lines 66 extending from the scanning line driving circuit 61, and a plurality of data lines 68 extending from the data line driving circuit 62. The pixels 40 are provided corresponding to intersection positions of the scanning lines 66 and the data lines 68. Furthermore, the display unit 5 is provided with a ramp waveform signal line 49 extending from the common power supply modulation circuit 64, a power line 50, and a common electrode wiring 55, and wirings of the ramp waveform signal line 49, the power line 50, and the common electrode wiring 55 are connected to the pixels 40. In addition, the common electrode wiring 55 refers to an electrical connection using a wiring between a common electrode 37 (refer to FIGS. 2 and 3), which is an electrode common to the plurality of pixels 40 of the display unit 5, and the common power supply modulation circuit 64 for descriptive purposes.

The scanning line driving circuit 61 is connected to the pixels 40 through m (Y1, Y2, . . . , Ym) scanning lines 66. Under the control of the controller 63, the scanning line driving circuit 61 sequentially selects the scanning lines 66 of 1^{st} to m^{th} rows, and supplies a selection signal for specifying the on timing of a select transistor TRs (refer to FIG. 2) provided at the pixels 40 through the selected scanning line 66. The data line driving circuit 62 is connected to the pixels 40 through n (X1, X2, . . . , Xn) data lines 68. Under the control of the controller 63, the data line driving circuit 62 supplies the pixels 40 with image signals for specifying image data corresponding to the pixels 40. Under the control of the controller 63, the common power supply modulation circuit 64 generates various signals to be supplied to each wiring, and performs electrical connection and disconnection (a high impedance state (Hi-Z)) of these wirings.

FIG. 2 is a circuit configuration diagram of the pixel 40.

The pixel 40 includes the select transistor TRs, a first driving transistor TRd, a second driving transistor TRe, a holding capacitor C1, a pixel electrode 35, an electrophoretic element 32, and a common electrode 37. Furthermore, the scanning line 66, the data line 68, the ramp waveform signal line 49, and the power line 50 are connected to the pixel 40. Each of the select transistor TRs, the first driving transistor TRd, and the second driving transistor TRe is an N-MOS (Negative Metal Oxide Semiconductor) transistor.

In addition, the select transistor TRs, the first driving transistor TRd, and the second driving transistor TRe may also be replaced with other types of switching elements having a function equal to those of the select transistor TRs, the first driving transistor TRd, and the second driving transistor TRe. For example, a P-MOS transistor may be used instead of the N-MOS transistor, or an inverter or a transmission gate may also be used.

The scanning line 66 is connected to the gate of the select transistor TRs, the drain of first driving transistor TRd is connected to the source of the select transistor TRs, and one electrode of the holding capacitor C1 and the gate of the second driving transistor TRe are connected to the drain of the select transistor TRs. The gate of the first driving transistor TRd is connected to the data line 68, and the source of the first driving transistor TRd is connected to the ramp waveform signal line 49. The source of the second driving transistor TRe is connected to the power line 50, and the drain of the second driving transistor TRe is connected to the other electrode of the holding capacitor C1 and the pixel electrode 35. The electrophoretic element 32 is interposed between the pixel electrode 35 and the common electrode 37.

In the pixel 40, the select transistor TRs serves as a pixel switching element that controls (permits or inhibits) the input of a potential to the pixel electrode 35, and the first driving transistor TRd serves as a switching element that controls input of a ramp waveform to the select transistor TRs. In more detail, in the period in which the select transistor TRs is turned on by the selection signal input through the scanning line 66 and the first driving transistor TRd is turned on by the image signal input through the data line 68, the ramp waveform of the ramp waveform signal line 49 is input to the gate of the second driving transistor TRe and the holding capacitor C1 through the first driving transistor TRd and the select transistor TRs. Consequently, the second driving transistor TRe is driven and the electrophoretic element 32 is driven by a current flowing through the second driving transistor TRe.

Next, FIG. 3A is a partial sectional view of the electrophoretic display device 100 including the display unit 5. The electrophoretic display device 100 has a configuration in which the electrophoretic element 32 including a plurality of arranged microcapsules 20 is interposed between an element substrate (a first substrate) 30 and an opposite substrate (a second substrate) 31.

In the display unit 5, a circuit layer 34, which includes the scanning line 66, the data line 68, the select transistor TRs, the first driving transistor TRd, the second driving transistor TRe and the like shown in FIGS. 1 and 2, is provided to the side of the element substrate 30 facing the electrophoretic element 32, and a plurality of pixel electrodes 35 are arranged on the circuit layer 34.

The element substrate 30 is made of glass, plastic and the like, and may not be transparent because it is disposed at an opposite side of an image display surface.

The pixel electrode 35 is obtained by sequentially stacking nickel plating and metal plating on a copper (Cu) foil, and applies a voltage to the electrophoretic element 32 made of aluminum (Al), ITO (Indium Tin Oxide) and the like.

Also, the common electrode 37 having a planar shape, which faces the plurality of pixel electrodes 35, is formed at the side of the opposite substrate 31 facing the electrophoretic element 32, and the electrophoretic element 32 is provided on the common electrode 37.

The opposite substrate 31 is made of glass, plastic and the like, and is a transparent substrate because it is disposed on an image display side. The common electrode 37 applies a voltage to the pixel electrodes 35 and the electrophoretic element 32, and is a transparent electrode made of magnesium-silver (MgAg), ITO (Indium Tin Oxide), IZO (Indium Zinc Oxide) and the like.

The electrophoretic element 32 is adhered to the pixel electrodes 35 through an adhesive layer 33 so that the element substrate 30 is bonded to the opposite substrate 31.

In addition, the electrophoretic element 32 is formed in advance at the side of the opposite substrate 31 and is generally treated as an electrophoretic sheet inclusive of the adhesive layer 33. In the manufacturing process, an electrophoretic sheet is treated in the state where a protective release sheet has been adhered to the surface of the adhesive layer 33. Then, the electrophoretic sheet, from which the release sheet has been peeled, is adhered to the separately manufactured element substrate 30 (including the pixel electrodes 35, various circuits and the like), so that the display unit 5 is formed. Thus, the adhesive layer 33 exists only in the side of the pixel electrodes 35.

FIG. 3B is a schematic sectional view of the microcapsule 20. The microcapsule 20, for example, has a grain size of about 50 μm, and is a spherical member including a dispersion medium 21, a plurality of white particles (electrophoretic particles) 27, and a plurality of black particles (electrophoretic particles) 26, which are encapsulated therein. As shown in FIG. 3A, the microcapsule 20 is interposed between the common electrode 37 and the pixel electrodes 35, and one or a plurality of microcapsules 20 are disposed in one pixel 40.

The outer shell (wall film) of the microcapsule 20 is formed using acryl resin such as polymethyl methacrylate or polyethyl methacrylate, urea resin, polymeric resin with transparency such as Gum Arabic, and the like.

The dispersion medium 21 is a liquid for dispersing the white particles 27 and the black particles 26 into the microcapsule 20. As the dispersion medium 21, it is possible to exemplify water, an alcoholic-based solvent (methanol, ethanol, isopropanol, butanol, octanol, methyl cellosolve and the like), esters (ethyl acetate, butyl acetate and the like), ketones (aceton, methylethyl, methyl isobutyl ketone and the like), aliphatic hydrocarbons (pentane, hexane, octane and the like), alicyclic hydrocarbons (cyclo hexane, methyl cyclo hexane and the like), aromatic hydrocarbons (benzene, toluene, benzenes having a long-chain alkyl group (xylene, hexyl benzene, hebutyl benzene, octyl benzene, nonyl benzene, decyl benzene, undecyl benzene, dodecyl benzene, tridecyl benzene, tetra decyl benzene and the like)), halogen hydrocarbons (methylene chloride, chloroform, carbon tetrachloride, 1,2-dichloroethane and the like), carboxylate, and the like.

Furthermore, other oils may be exemplified. These materials may be used singly or in a mixture. In addition, a surface active agent and the like may also be mixed therein.

The white particles 27, for example, are particles (polymer or colloid) including white pigments such as titanium dioxide, zinc oxide or antimony trioxide. For example, the white particles 27 are used after being negatively charged. The black particles 26, for example, are particles (polymer or colloid) including black pigments such as aniline black or carbon black. For example, the black particles 26 are used after being positively charged.

It is possible to add a charge control agent including particles such as an electrolyte, a surface active agent, metal soap, resin, rubber, oil, varnish or compound, a dispersion agent such as a titanium-based coupling agent, an aluminum-based coupling agent or a silane-based coupling agent, a lubricant, a stabilizing agent, and the like to the pigments, as is required.

Furthermore, instead of the black particles 26 and the white particles 27, for example, pigments of red, green, blue and the like may also be used. With such a configuration, red, green, blue and the like can be displayed on the display unit 5.

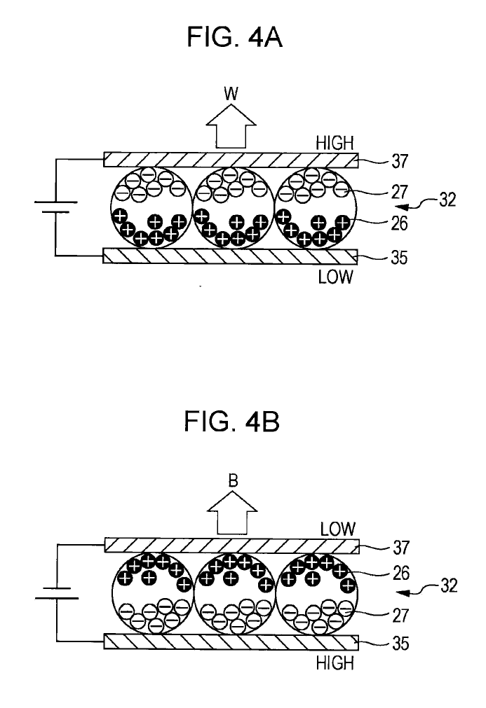

FIGS. 4A and 4B are diagrams explaining the operation of the electrophoretic element. FIG. 4A shows the case where the pixel 40 is displayed in white and FIG. 4B shows the case where the pixel 40 is displayed in black.

In the case of the white display shown in FIG. 4A, the potential of the common electrode 37 is relatively high and the potential of the pixel electrode 35 is relatively low. Thus, the negatively charged white particles 27 are drawn into the common electrode 37 and the positively charged black particles 26 are drawn into the pixel electrode 35. As a result, when the pixel is viewed from the side of the common electrode 37 serving as a display surface side, white (W) is recognized.

In the case of the black display shown in FIG. 4B, the potential of the common electrode 37 is relatively low and the potential of the pixel electrode 35 is relatively high. Thus, the positively charged black particles 26 are drawn into the common electrode 37 and the negatively charged white particles 27 are drawn into the pixel electrode 35. As a result, when the pixel is viewed from the side of the common electrode 37, black (B) is recognized.

### Driving Method

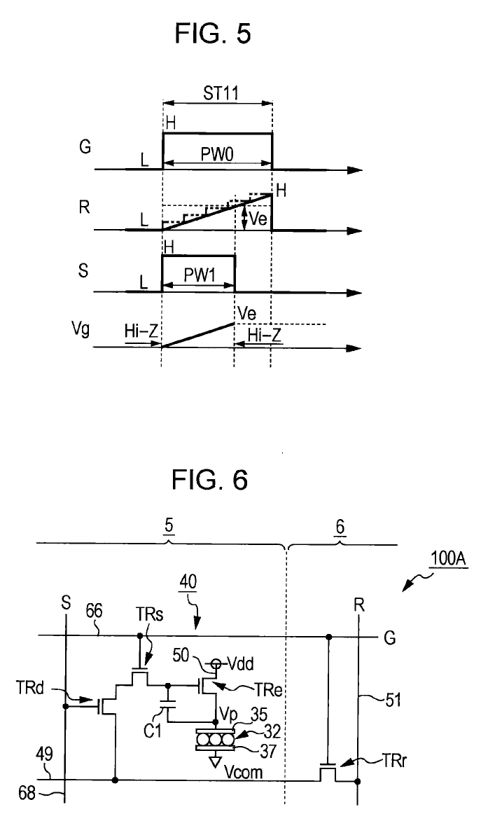

Next, the driving method of the electrophoretic display device in accordance with the first embodiment will be described with reference to FIG. 5.

FIG. 5 is a timing chart showing the driving method of the electrophoretic display device 100. FIG. 5 shows a change in potentials of the scanning line 66 (potential G), the power line 50 (potential R), the data line 68 (potential S), and the gate (potential Vg) of the second driving transistor with respect to one pixel 40 in the image display period ST11 in which an image is displayed on the display unit 5 of the electrophoretic display device 100.

In the image display period ST11, the scanning lines 66 of each row are sequentially selected by the scanning line driving circuit 61. As shown in FIG. 5, a potential (a high level), which allows the select transistor TRs to be turned on, is input to the selected scanning line 66 (potential G). Furthermore, in synchronization with the selection operation of the scanning line 66, a potential (a high level), which allows the first driving transistor TRd to be turned on, is input to the data lines 68 (potential S) of each column. In addition, in synchronization with the selection operation of the scanning line 66, a ramp waveform is supplied to the ramp waveform signal line 49 (potential R).

Herein, the potential level of the ramp waveform gradually changes over the image display period ST11. In the example shown in FIG. 5, from the start to the end of the image display period ST11, the potential R of the ramp waveform linearly changes from a low level to a high level.

However, the ramp waveform supplied to the ramp waveform signal line 49 may have a stepped shape as indicated by a double dotted line in FIG. 5. In addition, from the start to the end of the image display period ST11, the potential of the ramp waveform may be linearly reduced. Moreover, the potential of the ramp waveform may change in a curved line as with a logarithmic curve or an exponential curve.

In the case of the first embodiment, according to the above operation, a pulse width PW1 of a rectangular pulse input to the data line 68 is set to a desired length in the range of a selection period PW0 (a pulse width of a selection signal) of the scanning line 66 as shown in FIG. 5. Thus, the first driving transistor TRd is turned off at the point in time at which the potential of the ramp waveform input to the first driving transistor TRd through the ramp waveform signal line 49 reaches a predetermined value (a potential Ve In FIG. 5), so that the gate potential Vg of the second driving transistor TRe can be set to the potential Ve. At this time, the holding capacitor C1 is charged in the state where the potential of one electrode of the holding capacitor C1 connected to the gate of the second driving transistor TRe reaches Ve.

Thereafter, since the first driving transistor TRd is turned off and the select transistor TRs is also turned off, the holding capacitor C1 and the second driving transistor TRe are in a high impedance state. Therefore, since the voltage of both ends of the holding capacitor C1 is fixed, the second driving transistor TRe is driven with a constant current by energy accumulated in the holding capacitor C1, and a current flows between the power line 50 and the pixel electrodes 35. The electrophoretic element 32 is driven by the current, so that a desired grayscale display can be performed.

In accordance with the first embodiment as described above, an arbitrary potential can be selected from the potentials of the ramp waveform, which changes with the passage of time in the selection period, by the pulse width PW1 of the image signal input to the data line 68, and can be input to the gate of the second driving transistor TRe. Consequently, it is possible to freely control the gate potential Vg of the second driving transistor TRe and the holding voltage of the holding capacitor C1 and control the current flowing through the second driving transistor TRe, so that a multi-grayscale display can be realized without providing a circuit for supplying each data line with a plurality of potentials different from each other.

Furthermore, since the image signal input to the data line 68 has a pulse-width modulated waveform, binary control is possible and a complicated driving circuit is not necessary. In the first embodiment, the ramp waveform is used. However, since the ramp waveform signal line 49 is a wiring common to all the pixels 40 of the display unit 5 as shown in FIG. 1, the ramp waveform signal line 49 is driven by one circuit, so that the circuit configuration is prevented from being complicated.

Furthermore, in addition to the size of the second driving transistor TRe, it is possible to use a parasitic capacitance between the gate and the drain of the second driving transistor TRe in place of the holding capacitor C1. In addition, the other end of the holding capacitor C1 may also be connected to a separate holding capacitance line (not shown), through which a predetermined potential is supplied, instead of the drain of the second driving transistor TRe.

### Modified Example

FIG. 6 is a schematic configuration diagram of an electrophoretic display device 100A in accordance with a modified example of the first embodiment.

In the electrophoretic display device 100A in accordance with the modified example, as shown in FIG. 6, the ramp waveform signal line 49 is provided in correspondence with the scanning line 66 of each row of the display unit 5, and is connected to a main signal line 51 through a power transistor TRr at the position extended to a non-display unit 6 from the display unit 5. The gate of the power transistor TRr is connected to the scanning line 66 corresponding to the ramp waveform signal line 49 connected to the drain of the power transistor TRr. The source of the power transistor TRr is connected to the main signal line 51.

In the electrophoretic display device 100A having the above configuration in accordance with the modified example, a ramp waveform is input to the ramp waveform signal line 49 in synchronization with the selection operation of the scanning line 66. That is, only in the period in which a potential (high level) for allowing the select transistor TRs to be turned on is input to the scanning line 66, the power transistor TRr is turned on and the main signal line 51 is electrically connected to the ramp waveform signal line 49, so that the ramp waveform is supplied to the first driving transistor TRd through the ramp waveform signal line 49. If the scanning line 66 enters a non-selection state, the power transistor TRr is turned off and thus the ramp waveform signal line 49 enters a high impedance state.

In the previous embodiment shown in FIG. 1, when one ramp waveform signal line 49 extends into the display unit 5 and is connected to each pixel 40, the ramp waveform signal line 49 intersects each data line 68 at a plurality of places (which is equal to the number of the scanning lines 66). Thus, since the parasitic capacitance of the intersection parts is charged and discharged due to a change in the potential of the ramp waveform, a lot of power is consumed. On the other hand, the electrophoretic display device 100A in accordance with the modified example is similar to the previous embodiment in that a plurality of the ramp waveform signal lines 49 intersect the data lines 68. However, since the ramp waveform is normally input to only one ramp waveform signal lines 49 at the time of the operation, power consumption due to parasitic capacitance of the ramp waveform signal lines 49 and the data lines 68 can be significantly reduced. Furthermore, in the case of the modified example, since most of the ramp waveform signal lines 49 are in a high impedance state, charge and discharge generated by a change in the voltage of the data line 68 is significantly reduced.

As described above, according to the electrophoretic display device 100A in accordance with the modified example, power consumption can be reduced as compared with the previous first embodiment.

### Second Embodiment

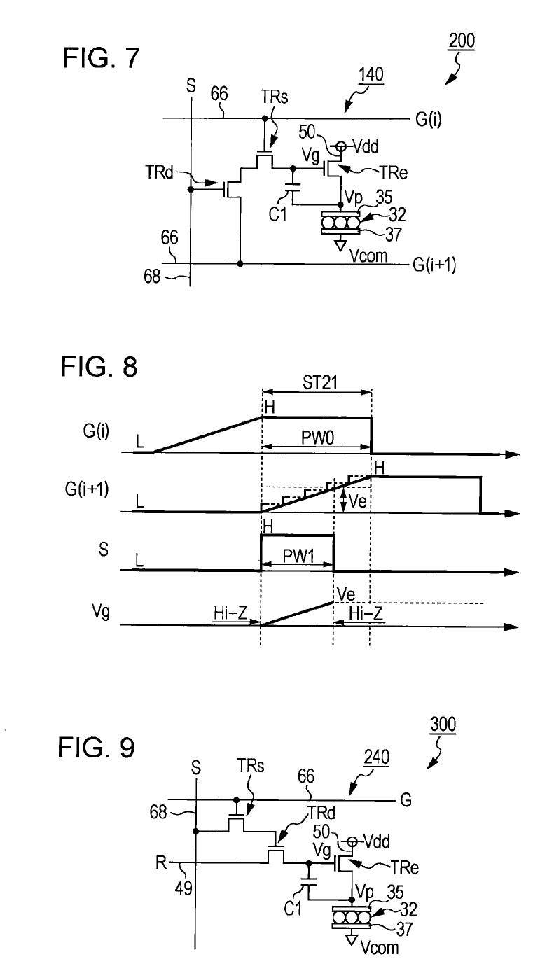

FIG. 7 is a diagram showing a pixel circuit of an electrophoretic display device 200 in accordance with a second embodiment of the present invention. FIG. 8 is a timing chart showing a driving method in accordance with the second embodiment. FIG. 8 shows a change in potentials of the scanning line 66 (potential G(i)) of an i^{th} row (1≦i≦m), the scanning line 66 (potential G(i+1)) of an (i+1)^{th} row, the data line 68 (potential S), and the gate (potential Vg) of the second driving transistor TRe with respect to one pixel 140 in the image display period ST21 in which an image is displayed on the display unit 5 of the electrophoretic display device 200. In addition, the scanning line 66 of the (i+1)^{th} row is selected after the scanning line 66 of the i^{th} row is selected in the selection operation of the scanning line driving circuit 61. Moreover, for the case where i=m, a dummy scanning line 66 of a (m+1)^{th} row, which does not contribute to the display, is provided.

As shown in FIG. 7, the pixel 140 of the electrophoretic display device 200 of the second embodiment has a configuration in which the source of the first driving transistor TRd is connected to a scanning line 66 of the next stage. Thus, the ramp waveform signal lines 49, which is provided as a wiring separate from the scanning line 66 in the first embodiment, is omitted.

Even in the electrophoretic display device 200 having the above configuration, a multi-grayscale display can be realized in a similar manner to the electrophoretic display device 100 of the first embodiment. In detail, as shown in FIG. 8, a waveform obtained by combining a ramp waveform with a rectangular pulse is input to the scanning line 66. In the pulse input to the scanning line 66, the rectangular wave corresponds to a signal (a selection signal) which allows the select transistor TRs to be turned on, and the ramp waveform with a potential which is gradually changed corresponds to a ramp waveform signal input to the gate of the second driving transistor TRe through the first driving transistor TRd.

In the image display period ST21 shown in FIG. 8, an image display operation of one pixel 140 belonging to the scanning line 66 of the i^{th} row is performed. In the image display period ST21, a potential (high level) for allowing the select transistor TRs to be turned on is input to the scanning line 66 of the i^{th} row. At this time, a ramp waveform with a potential which is gradually increased over the image display period ST21 is input to the scanning line 66 of the (i+1)^{th} row.

In synchronization with the selection operation of the scanning line 66, a potential (high level) for allowing the first driving transistor TRd to be turned on is input to the data line 68 (potential S) of each column. The pulse width PW1 of a rectangular pulse input to the data line 68 is set to a desired length in the range of a selection period PWOof the scanning line 66 as shown in FIG. 8.

Through the above operation, the first driving transistor TRd is turned off at the point in time at which the potential of the ramp waveform input to the first driving transistor TRd through the scanning line 66 of the (i+1)^{th} row reaches a predetermined value (a potential Ve In FIG. 8), so that the gate potential Vg (a potential of one electrode of the holding capacitor C1) of the second driving transistor TRe can be set to the potential Ve.

Thereafter, since the select transistor TRs and the first driving transistor TRd are turned off, the gate of the second driving transistor TRe and the holding capacitor C1 are in a high impedance state. Therefore, the second driving transistor TRe is driven with a constant current by energy accumulated in the holding capacitor C1. Consequently, the electrophoretic element 32 is driven by the current flowing through the pixel electrode 35 via the second driving transistor TRe, so that a desired grayscale display can be performed.

In a similar manner to the electrophoretic display device 100 of the first embodiment, even in the electrophoretic display device 200 of the second embodiment as described above, a multi-grayscale display can be performed without complicating the configuration of the driving circuit. Furthermore, in the second embodiment, since only the selected scanning line 66 and the scanning line 66 of the next row are simultaneously driven, power saving can be realized as with the electrophoretic display device 100A in accordance with the modified example of the first embodiment. In addition, in the case of the second embodiment, since the ramp waveform signal line 49 of the first embodiment is not necessary, it is advantageous in that it is easy to cope with high definition of pixels.

Moreover, in the previous embodiment, the ramp waveform is supplied to the first driving transistor TRd through the scanning line 66 of an adjacent row. However, in the case of scanning lines 66 of rows other than the row, scanning lines 66 of rows other than an adjacent row can also be used for supplying the ramp waveform. However, as shown in FIG. 8, in the case of using the scanning line 66 of the adjacent row, since it is possible to supply the selection signal and the ramp waveform as one continuous waveform, the scanning line driving circuit 61 can be prevented from being complicated.

### Third Embodiment

FIG. 9 is a diagram showing a pixel circuit of an electrophoretic display device 300 in accordance with a third embodiment of the present invention.

As shown in FIG. 9, a pixel 240 of the electrophoretic display device 300 in accordance with the third embodiment includes the select transistor TRs, the first driving transistor TRd, the second driving transistor TRe, the holding capacitor C1, the a pixel electrode 35, the electrophoretic element 32, and the common electrode 37. Furthermore, the scanning line 66, the data line 68, and the ramp waveform signal line 49 are connected to the pixel 240.

The scanning line 66 is connected to the gate of the select transistor TRs, the data line 68 is connected to the source of the select transistor TRs, and the gate of first driving transistor TRd is connected to the drain of the select transistor TRs. The ramp waveform signal line 49 is connected to the source of the first driving transistor TRd and the gate of the second driving transistor TRe is connected to the drain of the first driving transistor TRd. The power line 50 is connected to the source of the second driving transistor TRe, and the pixel electrode 35 is connected to the drain of the second driving transistor TRe. One electrode of the holding capacitor C1 is connected to the gate of the second driving transistor TRe, and the other electrode of the holding capacitor C1 is connected to the drain of the second driving transistor TRe. The ramp waveform is supplied to the ramp waveform signal line 49 similar to the previous first embodiment.

The electrophoretic display device 300 having the above configuration can realize a multi-grayscale display, which is similar to the first embodiment, by using the driving method similar to that of the electrophoretic display device 100 of the first embodiment shown in FIG. 5.

That is, in an image display operation, a potential (high level) for allowing the select transistor TRs to be turned on is input to the scanning line 66 and an image signal is input to the data line 68 in synchronization with this. The image signal corresponds to a rectangular wave set to the pulse width PW1 of a desired length in the range of the selection period PWOof the scanning line 66.

If so, the image signal is input to the gate of the first driving transistor TRd through the select transistor TRs in the turn-on state, and the first driving transistor TRd is turned on only in the period (the pulse width PW1) in which the image signal is input. Consequently, the first driving transistor TRd can be turned off when the potential of the ramp waveform supplied from the ramp waveform signal line 49 has reached a desired potential Ve, and the gate potential Vg (and the potential of one electrode of the holding capacitor C1) of the second driving transistor TRe can be set to the desired potential Ve. Thereafter, since the second driving transistor TRe and the holding capacitor C1 are maintained in a high impedance state, the second driving transistor TRe is driven with a constant current by the holding capacitor C1. The electrophoretic element 32 is driven by a current flowing between the power line 50 and the pixel electrode 35 through the second driving transistor TRe, so that a desired grayscale display can be performed.

As described above, even in the electrophoretic display device 300 in accordance with the third embodiment, a multi-grayscale display can be performed without complicating the configuration of the driving circuit, in a similar manner to the electrophoretic display device 100 in accordance with the first embodiment.

Furthermore, the configuration of the modified example of the first embodiment or the configuration of the second embodiment can be applied to the electrophoretic display device 300 in accordance with the third embodiment. By employing these configurations, power saving of the electrophoretic display device 300 can be realized. In addition, when employing a configuration similar to that of the second embodiment, since the ramp waveform signal line 49 is not necessary, it is advantageous that it is easy to cope with high definition of pixels.

### Electronic Apparatus

Next, the case where the electrophoretic display devices 100, 100A, 200 and 300 in accordance with the previous embodiments and modified example are applied to the electronic apparatus will be described.

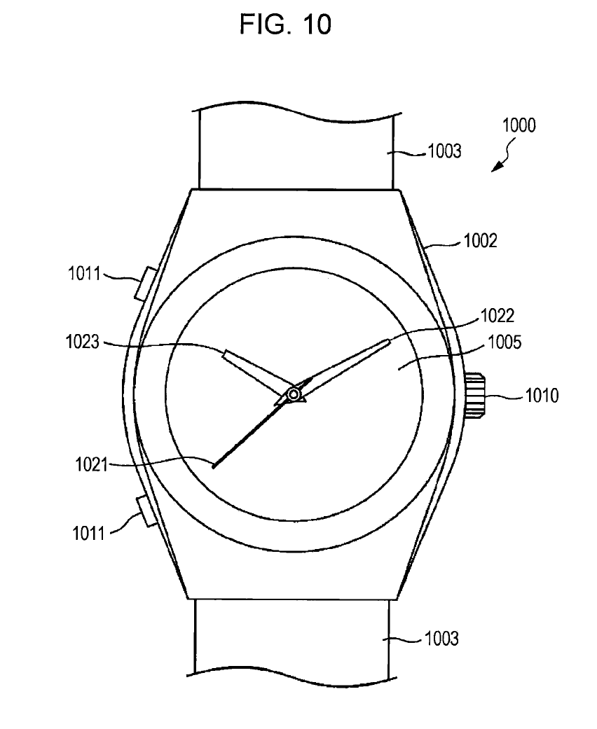

FIG. 10 is a front view of a watch 1000. The watch 1000 includes a watch case 1002 and a pair of straps 1003 connected to the watch case 1002.

The watch case 1002 is provided on the front surface thereof with a display unit 1005 of the electrophoretic display devices in accordance with each embodiment, a second hand 1021, a minute hand 1022 and an hour hand 1023. The watch case 1002 is provided on the side thereof with a winder 1010 as an operating element and an operation button 1011. The winder 1010 is connected to a winding stem pipe (not shown) provided in the case, and is configured to be freely pushed and drawn at multi-steps (e.g., two steps) as one body with the winding stem pipe, and to be freely rotated. The display unit 1005 can display a background image, a character string such as a date or a time, a second-hand, a minute hand, an hour hand and the like.

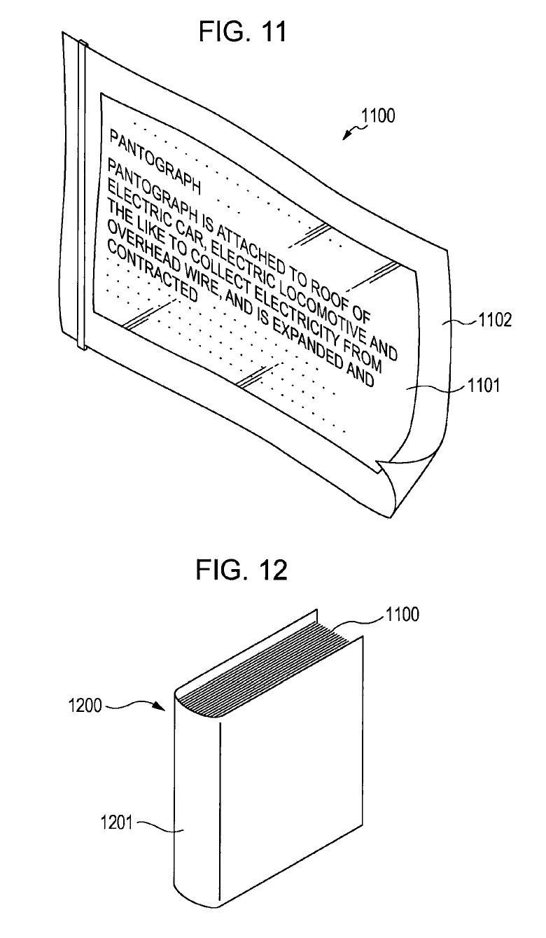

FIG. 11 is a perspective view showing the configuration of an electronic paper 1100. The electronic paper 1100 includes the electrophoretic display device of previous embodiment in a display area 1101. The electronic paper 1100 has flexibility and includes a body 1102 provided with a rewritable sheet having a similar feeling and flexibility of an existing paper.

FIG. 12 is a perspective view showing the configuration of an electronic note 1200. The electronic note 1200 is obtained by binding a plurality of electronic papers 1100 and interposing the electronic papers 1100 in a cover 1201. The cover 1201, for example, is provided with a display data input unit (not shown) that inputs display data sent from an external apparatus. Consequently, in the state where the electronic papers are bound, display contents can be changed or updated according to the display data.

The watch 1000, the electronic paper 1100 and the electronic note 1200 employ the electrophoretic display device in accordance with the present invention, resulting in the realization of an electronic apparatus provided with a display unit capable of performing a multi-grayscale display with a simple configuration.

In addition, the above electronic apparatuses exemplify an electronic apparatus in accordance with the present invention, and does not limit to the technical scope of the present invention. For example, the electrophoretic display device in accordance with the present invention can be appropriately applied to a display unit of an electronic apparatus such as a cell phone or a portable audio system.

The entire disclosure of Japanese Patent Application No. 2009-250326, filed Oct. 30, 2009 is expressly incorporated by reference herein.

1. An electrophoretic display device including an electrophoretic element interposed between a pair of substrates, a scanning line and a data line extending in directions intersecting each other, a pixel formed corresponding to an intersection part of the scanning line and the data line, and a power line connected to the pixel,
wherein the pixel is provided with a pixel electrode, a select transistor having a gate connected to the scanning line, a first driving transistor having a gate directly connected to the data line or connected to the data line through other elements, and a second driving transistor having a gate directly connected to a drain of the first driving transistor or connected to the drain of the first driving transistor through other elements, and a source connected to the power line,
a ramp waveform is input to the gate of the second driving transistor through the first driving transistor, and
a current flows between the power line and the pixel electrode through the second driving transistor.

2. The electrophoretic display device according to claim 1, wherein a second scanning line different from the scanning line connected to the pixel or a ramp waveform signal line for supplying the ramp waveform is connected to a source of the first driving transistor, and
a source of the select transistor is connected to the drain of the first driving transistor.

3. The electrophoretic display device according to claim 1, wherein a second scanning line different from the scanning line connected to the pixel or a ramp waveform signal line for supplying the ramp waveform is connected to a source of the first driving transistor, and
a drain of the select transistor is connected to the gate of the first driving transistor.

4. The electrophoretic display device according to claim 2, wherein the second scanning line and the scanning line connected to the pixel are adjacent to each other.

5. The electrophoretic display device according to claim 1, wherein a pulse with a pulse width equal to or less than a selection period of the pixel is input to the gate of the first driving transistor.

6. The electrophoretic display device according to claim 1, wherein the ramp waveform is supplied to the pixel only in a period in which a potential for allowing the select transistor to be turned on is input to the scanning line.

7. The electrophoretic display device according to claim 6, wherein a display unit is provided with a main signal line for supplying the ramp waveform and ramp waveform signal line formed corresponding to the scannling line to supply the ramp waveform to the pixel,
the ramp waveform signal line is connected to the main signal line through a signal control transistor, and
the scanning line is connected to a gate of the signal control transistor.

8. A driving method of an electrophoretic display device including an electrophoretic element interposed between a pair of substrates, a scanning line and a data line extending in directions intersecting each other, a pixel formed corresponding to an intersection part of the scanning line and the data line, and a power line connected to the pixel, whereby each pixel is provided with a pixel electrode, a select transistor having a gate connected to the scanning line, a first driving transistor having a gate directly connected to the data line or connected to the data line through other elements, and a second driving transistor having a gate directly connected to a drain of the first driving transistor or connected to the drain of the first driving transistor through other elements, and a source connected to the power line, the method comprising:
allowing the pixel to be in a selection state by turning on the select transistor at a state where a ramp waveform is supplied to a source of the first driving transistor when an image is displayed on a display unit;
inputting a part or the whole of the ramp waveform to the gate of the second driving transistor by allowing the first driving transistor to be selectively turned on in a predetermined period in a period in which the select transistor is turned on; and
allowing a current to flow between the power line and the pixel electrode through the second driving transistor.

9. The driving method according to claim 8, wherein the ramp waveform is supplied to the first driving transistor through a second scanning line different from the scanning line connected to the pixel.

10. The driving method according to claim 9, wherein the second scanning line and the scanning line connected to the pixel are adjacent to each other.

11. An electronic apparatus comprising the electrophoretic display device according to claim 1.

12. An electronic apparatus comprising the electrophoretic display device according to claim 2.

13. An electronic apparatus comprising the electrophoretic display device according to claim 3.

14. An electronic apparatus comprising the electrophoretic display device according to claim 4.

15. An electronic apparatus comprising the electrophoretic display device according to claim 5.

16. An electronic apparatus comprising the electrophoretic display device according to claim 6.

17. An electronic apparatus comprising the electrophoretic display device according to claim 7.
